(19) United States
(12) Patent Application Publication
(10) Pub. No.: US 2005/0113479 A1
(43) Pub. Date: May 26, 2005

(54) Novel shelf-stable photocurable silicone coating formulations

(76) Inventor: Richard Paul Eckberg, Saratoga Springs, NY (US)

Correspondence Address: Kenneth S. Wheelock;General Electric Company, One Plastics Avenue, Pittsfield, MA, 01201, US

(21) Appl. No.: 10/721,394

(22) Filed: Nov. 25, 2003

(51) Int. Cl. C08G 2/00

(52) U.S. Cl. 522/109

(57) ABSTRACT

Blends of epoxy-terminated and carbinol-terminated silicone polymers plus alkylphenol and iodonium photocatalyst additives comprise shelf-stable one-component ultraviolet light- or electron beam- curable release coating compositions.

### FIELD OF THE INVENTION

This invention relates to improved ultraviolet light curable silicone release coating compositions. More particularly, it relates to blends of telechelic reactive organofunctional polydiorganosiloxane silicone polymers with alkylphenols and compatible onium type photocatalysts.

### BACKGROUND OF THE INVENTION

Silicone coating compositions are useful for many applications including release (abhesive) coatings, protective coatings, and conformal coatings. These coatings are often applied to substrates as dispersions in a solvent system or emulsions in water in order to reduce the viscosity sufficiently so that the coating composition is easily coatable. The presence of the solvent, either water or some suitable low boiling organic solvent, necessitates evaporation. Thus, the application of heat to articles coated with silicones has served two purposes, removal of solvent and thermally induced curing. The elimination of solvent is desirable for two significant reasons: some organic solvents constitute an environmental and/or a safety hazard and elimination of evaporation reduces the energy requirements for preparation of the coated article. Elimination of the need for a heat curing step allows consideration of alternative curing mechanisms such as a radiation cure employing either actinic or electron beam radiation.

The absence of organic solvent from a coating composition lowers the necessary energy required for cure eliminating the need for costly pollution abatement equipment. This absence of solvent has a drawback insofar as some silicone coating compositions are thick, viscous mixtures that are difficult to coat without the viscosity reduction provided by the dilution of a solvent. Thus thin, defect-free, and uniform coatings are difficult to achieve with such materials. Certain photo-catalysts, particularly polar ‘onium type photo-catalysts, may require the presence of a compatibilizing solvent to render them soluble in nonpolar silicone coating mixtures.

Silicone compositions have long been used for rendering surfaces non-adherent to materials which would normally adhere thereto. Epoxy-functional silicones such as taught in U.S. Pat. No. 4,279,717, when combined with certain compatible iodonium cationic photo-catalysts, are known to be useful for release coating purposes. Epoxy-silicone release coatings allow high speed processing with minimal energy expenditures. If the viscosity of the coating composition exceeds 1,000 centistokes (cstk) at room temperature, the absence of solvent in the composition renders them difficult to apply, particularly if a thin coating on the order of 1 gm/m² is desired. The viscosity constraint imposed by processing equipment thus imposes constraints on the molecular weight of the silicone composition and on linearly functionalized photo-curable silicone fluids such as epoxy-silicones. Additional constraints are provided by the need for photo-catalyst miscibility or solubility, the need for a rapid photo-cure response, and good release performance. While a high epoxy content in an epoxy-silicone, as epoxy functional groups on a linear silicone molecule, tend to promote ‘onium photo-catalyst compatibility with the silicone and a rapid photo-cure, a low epoxy content is required for premium or low force release characteristics.

It is highly desirable to improve the ease of use of solvent-free silicone release coating formulations by providing such coating materials as ready-to-use one part products that do not require mixing of reactive components at the time of use. Thermally curable silicone release agents cannot be formulated as one part products because of inherently short mixed potlife, but photocurable silicone release agents can be so provided if the formulated mix is stable for long periods of time without undergoing crosslinking (curing) reactions under normal shelf conditions absent exposure to light. Conventional multi-functional epoxysilicones make up unstable UV curable coating formulations when blended with ‘onium type catalysts, that is, either incompletely miscible iodonium catalyst drops from suspension over a period of time, or the polymer crosslinks prior to use, thus rendering the product of no value to the user.

### SUMMARY OF THE INVENTION

The present invention is based on the discovery that certain telechelic reactive silicones, that is, linear polydialkylsiloxanes bearing reactive functional groups at the chainstopper position but not at other positions along polymer chains, when combined with alkylphenol additives and compatible iodonium salt photocatalysts, provide unexpectedly stable photocurable compositions readily applied to conventional substrates and efficiently cured to abhesive coatings on exposure to ultraviolet light. The compositions of the present invention, when coated and cured, also provide for unique and useful release properties and release performance from conventional pressure sensitive adhesives (PSA's) in the form of tapes or labels.

The present invention thus provides for an ultra-violet or electron beam curable silicone coating composition comprising:
a) an epoxy-terminated linear silicone selected from the group consisting of M^{E}DₓM^{E}, M^{GE}DₓM^{GE}, M^{E}DₓM^{GE} and mixtures thereof;
   where M^{E}=(C₆H₉O(CH₂CH₂)(CH₃)₂SiO_{1/2},
   M^{GE}=(CH₂₍O)CH)O(CH₂)₃(CH₃)₂SiO_{1/2}
   and D=(R¹)₂SiO_{2/2}
and x=0 or a positive integer wherein said epoxy-terminated silicone polymer has a viscosity ranging from about 10 to about 1000 centistoke at 25° C. and R¹ is a C1 to C60 monovalent hydrocarbon radical.
b) a carbinol functional silicone preferably selected from the group consisting of M^{ROH}D_{Y}M^{ROH} where M^{ROH} is selected from the group consisting of HO(CH₂)₃(CH₃)₂SiO_{1/2}, (HOCH₂)₂(C₂H₅)C(CH₂)₃(CH₃)₂SiO_{1/2} and

HOCH₂CH(OH)CH₂O(CH₂)₃(CH₃)₂SiO_{1/2}, with y=an integer such that the carbinol functional silicone has a viscosity ranging from about 50 to 5000 cstk at 25° C.
c) an effective amount of a bis(alkylphenyl) or alkylphenyl(phenyl) or alkoxyphenyl(phenyl) iodonium salt photocatalyst, said photocatalyst being selected from the salts of the group of acids consisting of hexafluoroantimonic acid, hexafluoroarsenic acid, hexafluorophosphoric acid, tetrafluobroic acid, tetra(perfluorophenyl)boric acid and mixtures thereof.
d) alkylphenol compounds selected from the group consisting of R_{b}—C₆H_{5-b}—OH where R is an independently selected monovalent hydrocarbon radical selected from group consisting of C1 to C60 straight alkyl, C3 to C60 branched chain alkyl, C2 to C60 straight chain alkenyl, and C3 to C60 branched chain alkenyl radicals where said R groups may be alpha-, beta- or gamma- to the phenolic OH functionality, and where b=1, 2, 3, 4, or 5. When b is greater than 1, the phrase “independently selected” means that each R group substituted onto the C₆H_{5-b} center may be the same or different.

The subscripts x and y of the telechelic reactive silicone polymers described above may be varied, and the relative amounts of each telechelic silicone polymer may also be varied within the constraints of providing for viscosity within a desired range.

### DETAILED DESCRIPTION OF THE INVENTION

The epoxy functional polydiorganosiloxane fluids provided by the instant invention are more specifically dialkylepoxysiloxy-chainstopped polydialkylsiloxane polymers. The carbinol functional polydiorganosiloxane fluids are more specifically dialkyl(HOR)siloxy-chainstopped polydialkylsiloxane polymers such that each chainstopper unit (terminal siloxy) contains at least one terminal hydroxy group bonded to a hydrocarbon link and thence to a terminal silicon atom.

The epoxy functionality is obtained when hydrogen atoms of the dialkylhydrogensiloxy chainstopper groups are reacted with organic molecules that contain both an ethylenic unsaturation and epoxide functionality via a hydrosilation addition reaction as taught in U.S. Pat. No. 5,258,480.

The carbinol functionality is obtained when organic molecules containing both HO—R— and ethylenic unsaturation are similarly reacted with hydrogen atoms of the dialkylhydrogensiloxy chainstopper groups as taught

The alkyl groups of the telechelic reactive dimethyl-organosiloxy chainstopped linear polydialkylsiloxane are preferably methyl groups. The ethylenically unsaturated epoxy or epoxide monomer is preferably an unsaturated cyclo-aliphatic epoxy compound such as 4-vinylcyclohexene oxide (VCHO), vinylnorbornenemonoxide, limonenemonoxide, or dicyclo-pentadienemonoxide. The ethylenically unsaturated carbinol or poly(carbinol) monomer is preferably allyl alcohol, the mono-allyl ether of glycerol, or the mono-allylether of trimethylol propane.

The hydrosilation reactions used for functionalization of silylhydride containing polysiloxanes are preferably catalyzed by trace amounts of Group VIII noble metal compounds. By Group VIII noble metals, applicants define the group to consist of the elements ruthenium, rhodium, palladium, osmium, iridium, and platinum.

The hydrogen functional siloxane precursor fluid can be selected from any chainlength of dimethylhydrogensiloxy chainstopped polydimethylsiloxanes including 1,1,3,3-tetramethylsiloxane.

Alkylphenols are well-known compounds in broad use as additives for many plastics' processing and applications. Most preferred alkylphenols for use in the instant invention are compounds including 4-nonylphenol, 4-dodecylphenol (DDP), and 2-allylphenol. It should be noted that commercial DDP is normally a mixture of various alkylphenols where the alkyl groups range from C₁₀ to C₁₄ in length and include branched chain groups as well as linear groups.

The chemical formulas of the compounds in the foregoing list are written without regard for the positional isomerism of the substituents. Specific structural isomers of these general formulas are commercially available and these specific examples are used in the experimental section demonstrating reduction to practice and utility. Therefore these compounds are claimed as the general structures with the expectation that geometric isomers having the same empirical and molecular formula will function sufficiently similarly to effect the purposes of this invention.

We have discovered that when the alkylphenol diluted epoxy-stopped plus carbinol-stopped silicone polymers described previously are combined with a miscible bis-aryl iodonium catalyst, the resulting mixture can be exposed to ultraviolet light or an electron beam to initiate a curing reaction that forms a solid silicone release coating which incorporates the photo-polymerized silicones together with the alkylphenol. We have unexpectedly discovered that the mixture of these particular reactive silicone polymers, alkylphenol, and iodonium photocatalyst possesses very long useful shelflife, so that this unique combination of materials can be produced as a one-part photocurable silicone product requiring no mixing or other manipulation by the user. We have also found that the release performance characteristics of fully cured coatings of these one-part UV cure formulated products are unlike those of conventional poly-functional UV cure epoxysilicone-based release coatings, but provide for a dynamic release profile comparable to those obtained with thermal cure solvent-free silicone coatings. We believe that both the long useful shelf-life and the release performance of the formulations of the instant invention result from exclusive use of telechelic structured reactive silicone polymers, that is, linear polydimethylsiloxane polymers bearing reactive organofunctional groups only at chain-termination positions on the molecule.

Ultraviolet light curable or electron beam curable epoxy-functional silicone compositions of the instant invention may be applied to cellulosic or plastic film substrates including but not limited to supercalendered kraft (SCK) paper, glassine paper, polyethylene kraft (PEK) paper, polyethylene film, polypropylene film, and polyester film. A reaction, initiated by an electron beam or ultraviolet light, cures the liquid silicone release coating to form a solid non-adherent, i.e. abhesive, release surface on the substrate so coated.

Acrylate functional silicones, such as those taught in U.S. Pat. No. 5,034,491 are also photo-curable in the presence of photo-initiators and may be formulated as one part photocurable release coatings. Photocurable acrylate silicone compositions that are photocurable in the presence of the more common free-radical photo-initiators typically require stabilizers, e.g. hydroquinone. Typical common photo initiators such as benzophenone and its derivatives are generally incompletely soluble in silicone media, as are most stabilizers. Low solubility leads to problems as to an appropriate choice of these necessary additives. Another problem associated with free-radical photocure silicone systems is the cure inhibition brought about by the presence of oxygen, which requires that the coated substrate be under an inert atmosphere such as nitrogen while undergoing ultraviolet radiation for a prompt cure response. While maintaining an inert atmosphere in an ultraviolet or electron beam cure chamber is feasible, the requirement for an inert atmosphere adds complications and expense to a coating and curing process.

It has previously been discovered that ultraviolet and/or electron beam curable epoxy-silicone polymers such as those taught by Eckberg et al. in U.S. Pat. No. 4,279,717 are efficiently cured in the presence of certain compatible onium-type cationic photocure catalysts without being subject to the drawback of being inhibited in the presence of oxygen. These epoxy-silicone compositions are constrained within a narrow range of viscosity and epoxy content that is dictated by the need for a defect free coating of about 0.5 to 2.0 microns thickness of the polymers that can be applied to the substrate at high application speeds and by the necessity for these photocurable compositions to quickly photocure upon exposure to ultraviolet light while maintaining good adhesion to the substrate.

Three roll offset gravure or multi-roll film splitting application techniques commonly practiced for the high speed coating of solvent free silicones requires that the silicones be in the range of 20 to 2000 centistokes viscosity at the temperature where applied, and rapid cure requires sufficient amount of reactive oxirane be present in the epoxy-silicone molecule to facilitate onium-type catalyst dissolution and to ensure a high reactivity of the system. If too much oxirane is reacted into the silicone fluid composition a photo cured epoxy-silicone composition with the desired release performance will not result.

The epoxy functional silicones included in the coating composition of the instant invention are preferably selected from the group consisting of
a) an epoxy functional silicone selected from the group consisting of an epoxy-terminated linear silicone selected from the group consisting of M^{E}DₓM^{E}, M^{GE}DₓM^{GE}, M^{E}DₓM^{GE} and mixtures thereof;
   where M^{E}=(C₆H₉O(CH₂CH₂)(CH₃)₂SiO_{1/2},
   M^{GE}=(CH₂₍O)CH)O(CH₂)₃(CH₃)₂SiO_{1/2}
   and D=(R¹)₂SiO_{2/2}
and x=0 or a positive integer wherein said epoxy-terminated silicone polymer has a viscosity ranging from about 10 to about 1000 centistoke at 25° C. and R¹ is a C1 to C₆₀ monovalent hydrocarbon radical, where x is a positive integer, and wherein said epoxy functional silicone has a viscosity ranging from about 10 to about 1000 centistokes at 25° C. Preferably R¹ is methyl.

The carbinol functional silicones included in the coating composition of the instant invention are selected from the group consisting of
M^{ROH}D_{Y}M^{ROH}
where M^{ROH} is selected from the group consisting of HO(CH₂)₃(CH₃)₂SiO_{1/2}, (HOCH₂)₂(C₂H₅)C(CH₂)₃(CH₃)₂SiO_{1/2} and HOCH₂CH(OH)CH₂O(CH₂)₃(CH₃)₂SiO_{1/2}, with y=an integer such that the carbinol functional silicone has a viscosity ranging from about 50 to 5000 cstk at 25° C.

An additional component is an alkylphenol compound selected from the group consisting of R_{b}—C₆H_{5-b}—OH where R is an independently selected monovalent hydrocarbon radical selected from group consisting of C1 to C₆₀ straight alkyl, C₃ to C₆₀ branched chain alkyl, C₂ to C₆₀ straight chain alkenyl, and C₃ to C₆₀ branched chain alkenyl radicals where said R groups may be alpha-, beta- or gamma- to the phenolic OH functionality, and where b=1, 2, 3, 4, or 5. When b is greater than 1, the phrase “independently selected” means that each R group substituted onto the C₆H_{5-b} center may be the same or different.

The requirement for a prompt efficient photocure militates that photo initiators and photosensitizers be freely miscible with the photo-crosslinkable compositions in which they are mixed, preferably forming clear solutions, but at least forming stable suspensions or dispersions. In the case of the epoxy-functional and carbinol-functional photocurable silicones of the instant invention, onium-type cationic photo catalysts must be compatible with the epoxy-silicone fluid. Iodonium salts of the general formula ((R-Ph)₂I)+X— have been designed to address the miscibility issue where R is typically a mixture of various alkyl fragments derived from linear alkylate grade dodecylbenzene and generically called dodecyl although the mixture is not pure dodecyl. As a consequence of the impurity of the dodecylbenzene, the compounds exhibit a freezing point depression relative to the pure compound and thus tend to exist in a non-crystalline, amorphous, semi-fluid state that is compatible with the epoxy-silicones of the instant invention. These dodecylbenzene-derived diphenyl iodonium cationic photocure catalysts are thus well-suited for use as photo catalysts for the ultraviolet cured epoxy-silicone release systems. The hexafluoroantimonate salts are most preferred for the compositions of the instant invention because they tend to combine high activity with excellent miscibility and are not prohibitively expensive to produce. We have found that alkylphenol reactive diluents are very effective in further aiding complete dissolution of iodonium salt photocatalysts in the compositions of the instant invention.

The UV curable one part silicone compositions of the present invention can be applied to cellulosic and other substrates including paper, metal, foil, glass, PEK paper, SCK paper, and polyethylene, polypropylene and polyester films. A UV initiated reaction will cure the epoxy functional silicone compositions of the present invention and form a non-adherent, abhesive surface on the coated substrate.

### DESCRIPTION OF THE PREFERRED EMBODIMENTS

Ultraviolet light curable silicone coating compositions of the present invention are obtained by combining an iodonium salt which is effective for catalyzing an ultraviolet light initiated cure reaction of the silicone coating composition, with a dialkylepoxysiloxy- chain-stopped linear polydialkylsiloxane fluid having a viscosity of approximately 10 to 1000 centistokes at 25° C. plus a dialkyl(carbinol)siloxy-chainstopped linear polydialkylsiloxane fluid having a viscosity of approximately 50 to 5000 centistoke at 25° C. plus sufficient compatible alkylphenol additive to assist complete dissolution of the iodonium salt catalyst in the coating medium.

The preferred UV-light initiator or photocatalyst utilized by the present invention is a diaryl iodonium salt derived from “linear alkylate” dodecylbenzene. Such salts have the following general formula:
((C_{z}H_{2z+1})-Ph)₂—I Y
wherein z is an integer varying from about 6 to about 18, Y equals SbF₆, AsF₆, PF₆, or BF₄ and Ph stands for a phenyl group. These bis(4-dodecylphenyl) iodonium salts are very effective initiators for the UV cure of a wide range of epoxy functional silicones. Most preferred is the salt where Y=SbF₆.

“Linear alkylate” dodecylbenzene is known commercially and is prepared by Friedel-Craft alkylation of benzene with a C₆-C₁₄ α-olefin cut. Consequently, the alkylate contains a preponderance of branched chain dodecylbenzene, but there may, in fact, be large amounts of other isomers of dodecylbenzene such as ethyldecylbenzene, plus isomer of undecylbenzene, tridecylbenzene and etc. Note, however, that such a mixture is responsible for the dispersive character of the linear alkylate derived catalyst and is an aid in keeping the material fluid. These catalysts are free-flowing viscous fluids at room temperature.

The bis-dodecylphenyl iodonium salts are profoundly different from previously characterized diaryliodonium salts. They are both pentane-soluble and water-insoluble. The improvements in solubility and catalytic efficiency of these branched chain substituted salts are further underscored by comparison with analogous salts prepared from straight chain n-tridecylbenzene and n-dodecylbenzene. Examples of these salts include bis(4-n-tridecylphenyl)iodonium hexafluoroantimonate which has long linear hydrocarbon chains. This salt is a waxy solid which is neither pentane nor water-soluble, and which disperses very poorly in the epoxy functional silicones utilized by the coating compositions of the present invention. This catalyst affords very sluggish UV cures when utilized for release coatings.

The UV curable silicone coating compositions of the present invention utilize epoxy-chainstopped linear silicone fluids. Epoxy compounds containing both unsaturation and oxirane, such as 4-vinylcyclohexeneoxide, react with silylhydride functional polysiloxanes via a hydrosilation reaction. An analogous hydrosilation reaction between vinyl siloxane groups and silylhydride functional polysiloxanes is a well-known means of crosslinking or curing silicone polymers.

The epoxy chainstopped silicones can be prepared from other vinyl-or allylic-functional compounds containing olefinic moieties such as allylglycidylether or glycidyl acrylate, vinylnorbornene monoxide and dicyclopentadiene monoxide. Although cyclohexyl epoxy compounds are particularly useful, other vinyl-functional cycloaliphatic epoxy or glycidyl ether compounds may also be used without significantly altering the intent of the invention. The scope of the invention is not limited to the epoxide species used in the examples.

The epoxy terminated linear silicone fluids and the (poly) carbinol terminated linear silicone fluids can be prepared in any of several ways. The following examples illustrates two such methods but it must be understood that the present invention is not limited by such examples. Those skilled in the art will be able to provide other organofunctional silicone intermediate fluids upon consideration of these examples. All U.S. patents referenced in this application are hereby and herewith incorporated by reference.

### EXAMPLES

Preparation of Organofunctional-Chainstopped Silicones

Preparation of Polymer A

310 grams of a dimethylhydrogen-siloxy chainstopped polydimethylsiloxane of approximate structure M^{H}D₂₂M^{H} were weighed into a 1 liter reaction flask. This polymer was a 21.7 cstk viscosity fluid, and included ˜1150 ppm reactive H, so that ˜0.36 moles SiH function were present in total. Sufficient ethanol solution of RhCl₃(Bu₂S)₃ was added to the polymer to provide for ˜5 ppm Rh in the polymer. This mixture was agitated at 90° C., then 46 grams (0.37 mole) of 4-vinyl cyclohexene oxide were added dropwise over a 15 minute period, resulting in an exothermic reaction that drove the batch temperature to 125° C. After holding at 90° C. for an hour, infrared analysis of the reaction mixture confirmed that <10 ppm H remained unreacted. 0.03 grams of methyldi-coco amine stabilizer was added to the batch prior to processing it through a laboratory scale thin film evaporator unit over a 2 hour period under a 0.5 torr vacuum at 200° C. to remove excess VCHO and siloxane light ends. The final devolatilized product was a 57.2 cstk viscosity fluid, 99.3% non-volatile content per a 45 minute 150° C. weightloss test. Polymer A can be depicted as M^{E}D₂₂M^{E}.

Preparation of Polymer B

200 grams of a dimethylhydrogensiloxy-chainstopped polydimethylsiloxane of approximate structure M^{H}D₁₃₀M^{H} were weighed into a 500 ml reaction vessel. This polymer included ˜205ppm reactive H, so that about 0.04 moles SiH function was present in total. Sufficient amount of a solution of conventional Karstedt platinum hydrosilation catalyst was added to provide ˜5 ppm Pt, then 6.1 grams of trimethylol propane mono-allyl ether (0.042 mole) were added. The complete mixture was agitated at 80° C. for two hours, after which time infrared spectral analysis revealed no SiH function present. The reaction product was subject to devolatilization in the same fashion as described for Polymer A, ultimately yielding a 900 centistoke viscosity polymer fluid, 98.8% non-volatile content. Polymer B can be depicted as M^{(ROH)2}D₁₃₀M^{(ROH)2}.

Other Formulation Inputs

Alkylphenol Additive C

A commercial alkylphenol consisting of a mixture of different isomers of 4-alkylphenol where the alkyl substituents ranged from —C₈H₁₇ to —C14H₂₉ centered at ‘dodecylphenol’ was used for compositions and experiments described below.

Photocatalyst Solution D

A commercial product consisting of a 50% solution of bis(4-dodecylphenyl) iodonium hexafluoroantimonate in a Ciba Specialties alkyl glycidyl ether called DY-025 was used for compositions and experiments described below.

One Component Photocurable Silicone Formulations

The following blends of the ingredients described above were prepared by simple mix of the 4 components. All of these compositions were clear, homogeneous fluids. Inputs are displayed in Table 1.

TABLE 1
One Part UV Curable Compositions

| Exp# | pts Polymer A | pts Polymer B | pts C | pts D | Blend Viscosity |
|---|---|---|---|---|---|
| A | 87.7 | 10.3 | 2 | 1 | 95 cstk |
| B | 85.0 | 10.0 | 5 | 1 | 101 cstk |
| C | 87.7 | 10.3 | 2 | 2 | 94 cstk |
| D | 85.0 | 10.0 | 5 | 2 | 103 cstk |
| E | 92.9 | 5.1 | 2 | 1 | 83 cstk |
| F | 90.0 | 5.0 | 5 | 1 | 90 cstk |
| G | 92.9 | 5.1 | 2 | 2 | 83 cstk |
| H | 90.0 | 5.0 | 5 | 2 | 89 cstk |

A 250 cps. Viscosity control mixture of 100 parts of a commercial polyepoxy-functional dimethylsilicone polymer, UV9400™, +1 part of catalyst D was prepared at the same time as the candidate one part compositions.

Following the preparation of these experimental and control photocatalysed coating mixtures, the viscosity of each mix was measured as a function of time upon storage in the dark at different temperatures. A doubling of viscosity is an arbitrary means of defining shelflife of a reactive solvent-free silicone coating composition. All samples were cooled to 25° C. for viscosity determination using a Brookfield model LVF viscometer, then returned to the controlled temperature environment of the experimental procedure. The tables to follow display the results of these measurements.

TABLE 2
40° C. Shelflife (Viscosity Build) (cps, Brookfield)

| Exp# | Initial | 2 wk | 4 wk | 5 wk | 6 wk | 7 wk | 8 wk | Shelflife |
|---|---|---|---|---|---|---|---|---|
| A | 95 | 108 | 144 | 185 | GEL | | | 5 wk |
| B | 101 | 121 | 296 | 543 | GEL | | | ˜3 wk |
| C | 94 | 115 | 134 | 149 | 214 | 1104 | GEL | 5 wk |
| D | 103 | 121 | 190 | 254 | 665 | GEL | | 4 wk |
| E | 83 | 99 | 134 | 189 | GEL | | | 4 wk |
| F | 90 | 104 | 795 | GEL | | | | 2 wk |
| G | 83 | 90 | 126 | 160 | 779 | GEL | | 5 wk |
| H | 89 | 103 | 297 | 552 | GEL | | | ˜3 wk |

| | | | | |
|---|---|---|---|---|
| Control | 250 | 502 | (GEL < 3 wks) | 2 wk |

The 40° C. shelflife experiment yielded unexpected results. Iodonium catalyst concentration inversely affected bath stability, as did DDP content. We observed that the ratio of polymer A to polymer B did not have much effect within the confines of the screening blends. Based on the 40° C. shelflife study, ambient and additional elevated temperature stability tests were carried out on selected formulations among those described above. Results are noted herein:

TABLE 3
60° C. Shelflife (Viscosity Build) (cps, Brookfield)

| Exp# | Initial | 2 day | 4 day | 7 day | 8 day | 9 day |
|---|---|---|---|---|---|---|
| C | 94 | 105 | 115 | 181 | 328 | GEL |
| E | 83 | 90 | 198 | (GEL˜6 day) | | |
| G | 83 | 93 | 212 | (GEL˜6 day) | | |
| Control | 250 | 309 | 1600 | (GEL˜5 day) | | |

TABLE 4
70° C. Shelfife (Viscosity Build) (cps, Brookfield)

| Exp# | Initial | 1day | 2day | 3day | 4day |
|---|---|---|---|---|---|
| C | 94 | 97 | 114 | 212 | GEL |
| E | 83 | 87 | 107 | 680 | GEL |
| Control | 250 | 276 | 495 | GEL | |

TABLE 5
25° C. Shelflife (Viscosity Build) (cps, Brookfield)

| Exp# | Initial | 3 month | 4 month | 5 month | 6 month | 7 month | 8month |
|---|---|---|---|---|---|---|---|
| B | 101 | 113 | 117 | 123 | 126 | 145 | 207 |
| E | 83 | 88 | 90 | 94 | 97 | 112 | 128 |
| Control | 250 | 363 | 3150 | GEL | | | |

The shelflife studies described above established that the unique formulation blends based on telechelic reactive linear polydimethyl-siloxanes possess sufficient ambient and elevated temperature stability to be useful products. We then established that thin films all of the test one part blends were photocurable on exposure to ultraviolet light. Each of the candidate compositions A through H plus the control blend were manually applied with a doctor blade to lay down ˜1.5 micron thick coating on a substrate consisting of a machine-finished paper on which HDPE was extruded to provide a smooth, uniform surface (this substrate is often called a polykraft, or PK liner). These coatings were then exposed to focused ultraviolet light from a 200 watt/in power Hanovia medium pressure mercury vapor lamp mounted in an RPC Lab UV Processor. Conveyer speed was varied to establish the maximum speed (minimum UV light exposure time) at which coatings cured to a migration-free abhesive surface; an EIT photometer was then run through the Processor at the same lamp and conveyer configuration and the UV dose obtained was recorded. The qualitative cure results are noted below:

TABLE 6
UV Dose Required for Cure, mJ/cm²

| Formula | UV Dose for Cure |
|---|---|
| A | 39 |
| B | 33 |
| C | 39 |
| D | 26 |
| E | 40 |
| F | 33 |
| G | 34 |
| H | 30 |
| Control | 26 |

While there is some variation within these results, it can be fairly stated that all compositions displayed similarly rapid photoresponse and rapidly crosslinked to solid abhesive coatings on brief exposure to UV light. Given that the control polymer includes numerous reactive cycloaliphatic epoxy groups along its polymer chain while all the candidate one part release coatings have reactive sites only at chain ends, the qualitative cure observation of rough equivalance of photocure response is unexpected.

Coating experiments then established that the novel one part UV curable compositions were easily coated on PK liner using conventional coating techniques, and that, when cured, these coatings are effective for release of pressure sensitive adhesives, that is, they function as useful release agents. Several compositions among those described above were prepared for coating trials on an 18 inch width pilot coater equipped with a 5 roll film-splitting nip-fed coating head. Coatings were applied to PK liner at a line speed of 400 ft/min with photocure effected by exposure of the coated silicone to one bank of 400 watt/in powered Fusion Systems™ H lamps. In-line corona treatment of the PK web to 45 dyne level aided anchorage of the silicone. Coatings were determined to be in the deposition range of 1.0-1.1 gram/m², or about a micron in thickness, thereby demonstrating that the relatively low viscosity of the one part coating blends does not compromise good control of coatweight. All coatings tested were cured to smear- and migration-free abhesive solids immediately offline at which time TESA7475 acrylic PSA test tape, TESA4651 rubber-based PSA test tape, and a commercial label facestock bearing an emulsion acrylic PSA were affixed to the silicone surfaces. Tapes were peeled from cured liner samples on aging of the laminates at room temperature or at elevated temperatures for varying lengths of time. A ZPE1000 High Speed peel tester and a TLMI peel release tester were used to record release force required to peel the silicone coated liners from adhesive at a 180° angle at fixed peel release velocity.

Release stability (as a function of laminate aging) and peel release profile (variation in force required to separate liner from tape as a function of peel speed) were measured. Release results are displayed in tables to follow.

TABLE 7
Release Stability vs TESA 7475 Acrylic Test Tape, 300 ipm peel

| | | | Ratio, | | |
|---|---|---|---|---|---|
| Coating | 1 day RT | 1 day 70 C. | 70 C./RT | 2 wk RT | 4 wk RT |
| B | 66.9 g/in | 66.6 g/in | 0.99 | 75.1 g/in | 60.0 g/in |
| E | 48.2 | 54.0 | 1.12 | 60.1 | 54.4 |
| Control | 17.3 | 32.3 | 1.87 | 27.2 | 25.6 |

Release of the one part UV cure coatings was higher than release of the control coating against the aggressive TESA 7475 acrylic PSA tape at 300 ipm peel speed, but release stability of the one part coatings is superior to that of the control coating, particularly at elevated temperature.

TABLE 8
Release Stability vs Emulsion Acrylic PSA
(Commercial Facestock), 300 ipm peel

| Coating | 1 day RT | 2 wk RT | 4 wk RT |
|---|---|---|---|
| B | 6.8 g/2 in | 12.6 g/2 in | 13.1 g/2 in |
| E | 5.9 | 13.0 | 11.3 |
| Control | 8.5 | 10.1 | 9.2 |

Release of all coatings tested from the emulsion acrylic PSA facestock construction was uniformly low, demonstrating that the novel one part UV cure release coatings' release from this conventional PSA is about the same as that of the control UV cure epoxysilicone coating, although not quite as stable.

TABLE 9
Release Stability vs TESA 4651 Rubber based
PSA test tape, 300 ipm peel, g/in

| Coating | 3day RT | 18 day RT | 5 wk RT | % build on aging |
|---|---|---|---|---|
| B | 38.8 | 43.5 | 52.8 | 136% |
| C | 55.2 | 63.5 | 67.3 | 122% |
| E | 31.1 | 33.8 | 40.3 | 130% |
| G | 34.2 | 30.6 | 42.9 | 125% |
| Control | 9.6 | 11.3 | 14.7 | 153% |

In this case, release of cured one part formulations showed significant variation one from another; coatings that included higher content of the longer chain-length polymer B (B and C) displayed higher release at 300 ipm versus the rubber based PSA tape, consistent with lower crosslink density and lower modulus coating (more elastomeric silicone) and use of a rubbery, elastic PSA on the tape. The highly crosslinked control coating shows rigid, high modulus behavior evinced in lower release force as it is peeled from the rubbery PSA. The absolute value of release is not as important as the stability of release since different applications require different release performance behavior.

TABLE 10
Peel Release Profile: 180° angle release from TESA 7475
acrylic test tape, isokinetic peel velocity, meter/second
(2 wk RT aged laminate) Release in g/in

| | Peel Speed, m/s | | | | | | | |
|---|---|---|---|---|---|---|---|---|
| Coating | 0.005 | 0.05 | 0.125 | 0.250 | 0.500 | 1.00 | 2.00 | 4.00 |
| B | 22.3 | 48.3 | 69.4 | 86.3 | 118 | 131 | 174 | 197 |
| C | 21.7 | 40.8 | 64.7 | 86.2 | 113 | 121 | 149 | 187 |
| E | 19.0 | 36.7 | 55.7 | 74.1 | 99.4 | 114 | 162 | 184 |
| G | 25.1 | 45.2 | 71.0 | 87.5 | 114 | 120 | 173 | 178 |
| Control | 18.7 | 20.0 | 22.7 | 23.9 | 30.2 | 37.1 | 42.2 | 37.1 |

These results are consistent with the 300 in/min peel results reported in Table 6 above. A peel speed of 0.125 meter/sec. is equivalent to 300 ipm; peel speed of 0.005 m/s is about the same as 12 in/min peel, a common measure of low speed ‘hand peel’ performance of a release liner. Peel profile of the representative one part UV cure release coatings is very different from that of the control UV cure release coating. While low peel speed release (‘hand peel’) is roughly comparable, the one-part coatings require much greater force to peel from the adhesive tape as peel speed is increased than the control coating. Such dynamic peel release behavior is very unusual for radiation cured silicone release agents that normally display the ‘flat’ peel profile observed in this case for the control coating. Dynamic peel release profile is highly desirable for release liners used in high speed automated labeling converting processes, as such performance prevents ‘premature dispensing’ of labels before they can be applied to such articles as bottles, boxes, or other product containers. Dynamic peel release profile is normally provided by solvent-free thermally cured silicone compositions wherein a dimethylvinyl-siloxy-stopped linear silicone base polymer is crosslinked by a poly(methylhydrogen)siloxane polymer in the presence of platinum-type hydrosilation catalysts, as is well known to those skilled in the art. A separate experiment was carried out to compare such a thermal cure two part silicone release agent (using a commercial product, SL6625™, a vinyl-terminated linear silicone as base polymer) with two representative one-part UV cure release agents selected from table 1 above, along with the UV control coating. A 12 inch width pilot coater equipped with a 3 roll offset gravure coating head was used to provide ˜1.2 gsm silicone deposition. 2.0 mil polyester film was selected as substrate; cure of the thermal silicone was effected by exposure of the coated PET to 120° C. oven temperature for ˜3 seconds' dwell. Cure of the one part UV silicone coatings and of the UV control resulted from exposure of the silicone to ˜100 mJ/cm² focused UV radiation provided by a Fusion Systems™ H lamp. TESA 7475 acrylic test tape was affixed to each coating immediately on cure, the taped release liners then aged for two weeks at 25° C. and peel profile determined as described above. The results of this study are summarized in Table 11.

TABLE 11
Peel Release Profile Comparison, Thermal Cure Silicone vs. One
Part UV Cure Silicone Release Agents (release in g/in)

| | Peel Speed, m/s | | | | | | |
|---|---|---|---|---|---|---|---|
| Coating | 0.005 | 0.125 | 0.25 | 0.50 | 1.0 | 2.0 | 4.0 |
| Thermal Control | 15.6 | 28.1 | 37.5 | 40.8 | 49.1 | 57.0 | 67.0 |
| B | 17.7 | 39.0 | 48.0 | 60.2 | 72.5 | 84.0 | 89.9 |
| E | 16.3 | 35.0 | 45.0 | 55.2 | 66.9 | 80.4 | 88.5 |
| UV Control | 13.3 | 18.2 | 23.0 | 24.2 | 28.4 | 30.0 | 28.0 |

Release of PSA's from stiff PET liners is normally lower than release from PK type liners, as is observed in this case. While the thermal cure silicone provides somewhat lower release than the one part UV coatings do in this set of observations, the dynamic peel profiles of the Thermal control and of the one part UV cure coatings are very similar and very different from the flat profile of the UV control coating. Of course, the convenience and ease of use of a one part silicone coating is not possible for any commercial thermal cure solvent free silicone formulation.

1. An ultraviolet or electron beam curable silicone coating composition comprising:
(a) an epoxy-terminated linear silicone selected from the group consisting of M^{E}DₓM^{E}, M^{GE}DₓM^{GE}, M^{E}DₓM^{GE} and mixtures thereof;
where M^{E}=(C₆H₉O(CH₂CH₂)(CH₃)₂SiO_{1/2},
M^{GE}=(CH₂₍O)CH)O(CH₂)₃(CH₃)₂SiO_{1/2}
and D=(R¹)₂SiO_{2/2}
and x=0 or a positive integer wherein said epoxy-terminated silicone polymer has a viscosity ranging from about 10 to about 1000 centistoke at 25° C.
(b) a mono- or poly-carbinol—terminated linear silicone selected from the group consisting of M^{ROH}D_{y}M^{ROH} and mixtures thereof;
where M^{ROH} is seklected from the group consisting of HO(CH₂)₃(CH₃)₂SiO_{1/2}, (HOCH₂)₂(C₂H₅)C—O—(CH₂)₃(CH₃)₂SiO_{1/2}, and HOCH₂(HO)CHCH₂—O—(CH₂)₃(CH₃)₂SiO_{1/2} where y=0 or a positive integer wherein said mono- or poly-carbinol—terminated silicone polymer has a viscosity ranging from about 50 to about 5000 centistoke at 25° C.
(c) an effective amount of a bis(alkylphenyl) or alkylphenyl(phenyl) or alkoxyphenyl(phenyl) or bis(alkoxyphenyl) iodonium salt photocatalyst, said photocatalyst being selected from the salts of the group of acids including hexafluoroantimonic acid, hexafluoroarsenic acid, hexafluorophosphoric acid, tetrafluoroboric acid, tetra(perfluorophenyl)boric acid and mixtures thereof
(d) an alkylphenol compound selected from the group consisting of R is an independently selected monovalent hydrocarbon radical selected from group consisting of C1 to C₆₀ straight alkyl, C₃ to C₆₀ branched chain alkyl, C₂ to C₆₀ straight chain alkenyl, and C₃ to C₆₀ branched chain alkenyl radicals where said R groups may be alpha-, beta- or gamma- to the phenolic OH functionality, and where b=1, 2, 3, 4, or 5.

2. The composition of claim 1 wherein component (a) ranges from about 50 to about 95% of the composition comprising components (a), (b), (c), and (d) and wherein component (b) ranges from about 2 to about 49% of the composition comprising components (a), (b), (c), and (d), and wherein component (c) ranges from about 0.1 to about 2.5% of the composition comprising components (a), (b), (c), and (d), and wherein component (d) ranges from about 0.5 to about 10% of the composition comprising components (a), (b), (c), and (d).

3. The composition of claim 1 wherein component (a) ranges from about 75 to about 95% of the composition comprising components (a), (b), (c), and (d) and wherein component (b) ranges from about 5 to about 25% of the composition comprising components (a), (b), (c), and (d), and wherein component (c) ranges from about 0.5 to about 2% of the composition comprising components (a), (b), (c), and (d), and wherein component (d) ranges from about 1 to about 5% of the composition comprising components (a), (b), (c), and (d).

4. The composition of claim 1 wherein component (a) ranges from about 80 to about 95% of the composition comprising components (a), (b), (c), and (d) and wherein component (b) ranges from about 5 to about 20% of the composition comprising components (a), (b), (c), and (d) and wherein component (c) ranges from about 0.5 to about 1% of the composition comprising components (a), (b), (c), and (d) and wherein component (d) ranges from about 2 to about 5% of the composition comprising components (a), (b), (c), and (d).

5. The composition of claim 1 wherein the epoxy-terminated silicone is M^{E}DₓM^{E}.

6. The composition of claim 5 wherein component (a) ranges from about 50 to about 95% of the composition comprising components (a), (b), (c), and (d) and wherein component (b) ranges from about 2 to about 49% of the composition comprising components (a), (b), (c), and (d), and wherein component (c) ranges from about 0.1 to about 2.5% of the composition comprising components (a), (b), (c), and (d), and wherein component (d) ranges from about 0.5 to about 10% of the composition comprising components (a), (b), (c), and (d).

7. The composition of claim 5 wherein component (a) rges from about 75 to about 95% of the composition comprising components (a), (b), (c), and (d) and wherein component (b) ranges from about 5 to about 25% of the composition comprising components (a), (b), (c), and (d), and wherein component (c) ranges from about 0.5 to about 2% of the composition comprising components (a), (b), (c), and (d), and wherein component (d) ranges from about 1 to about 5% of the composition comprising components (a), (b), (c), and (d).

8. The composition of claim 5 wherein component (a ranges from about 80 to about 95% of the composition comprising components (a), (b), (c), and (d) and wherein component (b) ranges from about 5 to about 20% of the composition comprising components (a), (b), (c), and (d) and wherein component (c) ranges from about 0.5 to about 1% of the composition comprising components (a), (b), (c), and (d) and wherein component (d) ranges from about 2 to about 5% of the composition comprising components (a), (b), (c), and (d).

9. The composition of claim 1 wherein the epoxy-functional silicone is M^{GE}DₓM^{GE}

10. The composition of claim 9 wherein component(a) ranges from about 50 to about 95% of the composition comprising components (a), (b), (c), and (d) and wherein component (b) ranges from about 2 to about 49% of the composition comprising components (a), (b), (c), and (d), and wherein component (c) ranges from about 0.1 to about 2.5% of the composition comprising components (a), (b), (c), and (d), and wherein component (d) ranges from about 0.5 to about 10% of the composition comprising components (a), (b), (c), and (d).

11. The composition of claim 9 wherein component (a) ranges from about 75 to about 95% of the composition comprising components (a), (b), (c), and (d) and wherein component (b) ranges from about 5 to about 25% of the composition comprising components (a), (b), (c), and (d), and wherein component (c) ranges from about 0.5 to about 2% of the composition comprising components (a), (b), (c), and (d), and wherein component (d) ranges from about 1 to about 5% of the composition comprising components (a), (b), (c), and (d).

12. The composition of claim 9 wherein component (a) ranges from about 80 to about 95% of the composition comprising components (a), (b), (c), and (d) and wherein component (b) ranges from about 5 to about 20% of the composition comprising components (a), (b), (c), and (d) and wherein component (c) ranges from about 0.5 to about 1% of the composition comprising components (a), (b), (c), and (d) and wherein component (d) ranges from about 2 to about 5% of the composition comprising components (a), (b), (c), and (d).

13. The composition of claim 1 wherein the carbinol-terminated silicone is M^{ROH}D_{y}M^{ROH}.

14. The composition of claim 13 wherein component (a) ranges from about 75 to about 95% of the composition comprising components (a), (b), (c), and (d) and wherein component (b) ranges from about 5 to about 25% of the composition comprising components (a), (b), (c), and (d), and wherein component (c) ranges from about 0.5 to about 2% of the composition comprising components (a), (b), (c), and (d), and wherein component (d) ranges from about 1 to about 5% of the composition comprising components (a), (b), (c), and (d).

15. The composition of claim 13 wherein component(a) ranges from about 75 to about 95% of the composition comprising components (a), (b), (c), and (d) and wherein component (b) ranges from about 5 to about 25% of the composition comprising components (a), (b), (c), and (d), and wherein component (c) ranges from about 0.5 to about 2% of the composition comprising components (a), (b), (c), and (d), and wherein component (d) ranges from about 1 to about 5% of the composition comprising components (a), (b), (c), and (d).

16. The composition of claim 13 wherein component (a) ranges from about 80 to about 95% of the composition comprising components (a), (b), (c), and (d) and wherein component (b) ranges from about 5 to about 20% of the composition comprising components (a), (b), (c), and (d) and wherein component (c) ranges from about 0.5 to about 1% of the composition comprising components (a), (b), (c), and (d) and wherein component (d) ranges from about 2 to about 5% of the composition comprising components (a), (b), (c), and (d).

17. The composition of claim 1 wherein the carbinol-terminated silicone is M^{(ROH)2}D_{y}M^{(ROH)2}

18. The composition of claim 17 wherein component (a) ranges from about 50 to about 95% of the composition comprising components (a), (b), (c), and (d) and wherein component (b) ranges from about 2 to about 49% of the composition comprising components (a), (b), (c), and (d), and wherein component (c) ranges from about 0.1 to about 2.5% of the composition comprising components (a), (b), (c), and (d), and wherein component (d) ranges from about 0.5 to about 10% of the composition comprising components (a), (b), (c), and (d).

19. The composition of claim 17 wherein component (a) ranges from about 75 to about 95% of the composition comprising components (a), (b), (c), and (d) and wherein component (b) ranges from about 5 to about 25% of the composition comprising components (a), (b), (c), and (d), and wherein component (c) ranges from about 0.5 to about 2% of the composition comprising components (a), (b), (c), and (d), and wherein component (d) ranges from about 1 to about 5% of the composition comprising components (a), (b), (c), and (d).

20. The composition of claim 17 wherein component (a) ranges from about 80 to about 95% of the composition comprising components (a), (b), (c), and (d) and wherein component (b) ranges from about 5 to about 20% of the composition comprising components (a), (b), (c), and (d) and wherein component (c) ranges from about 0.5 to about 1% of the composition comprising components (a), (b), (c), and (d) and wherein component (d) ranges from about 2 to about 5% of the composition comprising components (a), (b), (c), and (d).

21. The composition of claim 1 wherein the photocatalyst is a bis(alkylphenyl) iodonium hexafluoroantimonate.

22. The composition of claim 1 wherein the alkylphenol is 4-dodecylphenol.

23. An ultraviolet or electron beam curable silicone coating composition consisting essentially of:
(a) an epoxy-terminated linear silicone selected from the group consisting of M^{E}DₓM^{E}, M^{GE}DₓM^{GE}, M^{E}DₓM^{GE} and mixtures thereof;
where M^{E}=(C₆H₉O(CH₂CH₂)(CH₃)₂SiO_{1/2},
M^{GE}=(CH₂₍O)CH)O(CH₂)₃(CH₃)₂SiO_{1/2}
and D=(R¹)₂SiO_{2/2}
and x=0 or a positive integer wherein said epoxy-terminated silicone polymer has a viscosity ranging from about 10 to about 1000 centistoke at 25° C. and R¹ is a C1 to C₆₀ monovalent hydrocarbon radical.
(b) a mono- or poly-carbinol—terminated linear silicone selected from the group consisting of M^{ROH}D_{y}M^{ROH} and mixtures thereof; where M^{ROH} is seklected from the group consisting of HO(CH₂)₃(CH₃)₂SiO_{1/2}, (HOCH₂)₂(C₂H₅)C—O—(CH₂)₃(CH₃)₂SiO_{1/2}, and HOCH₂(HO)CHCH₂—O—(CH₂)₃(CH₃)₂SiO_{1/2} where y=0 or a positive integer wherein said mono- or poly-carbinol—terminated silicone polymer has a viscosity ranging from about 50 to about 5000 centistoke at 25° C.
(c) an effective amount of a bis(alkylphenyl) or alkylphenyl(phenyl) or alkoxyphenyl(phenyl) or bis(alkoxyphenyl) iodonium salt photocatalyst, said photocatalyst being selected from the salts of the group of acids including hexafluoroantimonic acid, hexafluoroarsenic acid, hexafluorophosphoric acid, tetrafluoroboric acid, and
(d) alkylphenol compounds selected from the group consisting of R_{b}—C₆H_{5-b}—OH where R=a straight chain or branched chain saturated or unsaturated hydrocarbon ranging in stoichiometry from CH₃— to about C₃₀H₆₁, and where said alkyl groups may be alpha-, beta-, or gamma- to the phenolic OH function, and where b is an integer ranging from 1 to 5.
